(19) United States
(12) Patent Application Publication
(10) Pub. No.: US 2010/0295257 A1
(43) Pub. Date: Nov. 25, 2010

(54) DRILL CHUCK

(76) Inventor: Hans-Dieter Mack, Sontheim (DE)

Correspondence Address: KF ROSS PC, 5683 RIVERDALE AVENUE, SUITE 203 BOX 900, BRONX, NY, 10471-0900, US

(21) Appl. No.: 12/671,215

(22) PCT Filed: Mar. 13, 2008
(86) PCT No.: PCT/DE08/00433

§ 371 Date: Mar. 23, 2010

(30) Foreign Application Priority Data
Aug. 31, 2007 (DE) 20 2007 012 199.7

(51) Int. Cl. B23B 31/16

(52) U.S. Cl. 279/68

(57) ABSTRACT

The invention relates to a drill chuck with means for connecting a chuck body (2) to a drive spindle, with a clamping cone (4), which is rotatable coaxially in relation to the chuck body (2), and with a jaw holder (5), in which clamping jaws (7) are guided in guiding slots (6), wherein said clamping jaws are guided in a radially adjustable manner on a drive element (8) and can be adjusted for clamping and releasing by a relative rotation between the chuck body (2) and the clamping cone (4). The drive element (8) engages with a drive element thread (9) in a body thread (10) of the chuck body (2) that is formed coaxially in relation to the chuck axis, and formed on the chuck body (2) are helical teeth (11), which are coaxial in relation to the chuck axis and in which there engages an externally accessible worm (13), which is mounted in the connecting means, has a coupling element (12) and a worm axis oriented perpendicularly in relation to the chuck axis and offset by the sum of the radii of the chuck body (2) and the worm (13). The coupling element is formed by a Torx socket (14) formed in the externally accessible end face (15) of the worm (13).

The invention relates to a drill chuck with means for connecting a chuck body to a drive spindle, a tapered tightening sleeve rotatable coaxially relative to the chuck body, and a jaw guide having slots in which jaws are slidable, the jaws being radially displaceable by a pusher for clamping and releasing on relative rotation of the chuck body and the tightening sleeve, to which end the pusher has a screwthread engaged in a screwthread of the chuck body that is coaxial to a chuck axis, an array of helical teeth being formed on the chuck body that is coaxial to the chuck axis and into which engages an externally accessible worm having a coupling formation, mounted in the connecting means, and having a worm axis perpendicular to the chuck axis and offset therefrom by a distance equal to the sum of the radii of the chuck body and of the worm.

Such drill chucks are known in practice, where a special embodiment is equipped with a steep-angle taper or functionally comparable structures, such as hollow shaft taper seats as means for connecting the chuck body having the drive spindle of a machine, the steep-angle taper further comprising handling formations by means of which an automatic refitting of the drill chuck is enabled. Due to the further improvement of the work machines working at increasingly higher speeds and torques, increasingly higher demands are made of the drill chucks.

The object of the invention is therefore to create a drill chuck of the above-mentioned type such that the life of the drill chuck is prolonged and the tension force achievable via the life is increased.

The object is attained according to the invention in a drill chuck of the type mentioned above in that the coupling formation is formed by a Torx socket formed in the externally accessible end face of the worm.

This configuration results in the advantage that higher gripping forces and higher torsional torques may be achieved even by counterclockwise rotation of the worm with the Torx socket, the permanent load being improved and an increased number of tension cycles being ensured. This is substantially aided by the fact that higher torques for gripping the tool shaft may be transferred between the tension cutting of the jaws, and spreading of the Torx socket is likely or is non-critical. For this purpose the Torx socket is to be understood herein in the broadest sense thereof, and also includes the modifications thereof, i.e. Torx Plus® or external Torx®One in addition to the Torx according to EN ISO 10664.

It is also of advantage if the end of the worm opposite the end face is cup-shaped. Forming the end of the worm opposite the end face as a cup spares the use of the prior-art ball bearing that is inserted in a center bore so that production costs of the ball bearing, of the mounting it in the center bore, and installation costs of the ball bearing can be dispensed with. Furthermore, the cup-shaped end provides for an improved life of the worm, while providing a higher capacity due to the one-piece production of the worm, since the wall in the region of the omitted center bore is no longer weakened.

To this end it is preferred if the cup-shaped end is semispherical, as the transition from the cup-shaped end to the cylindrical base form of the worm is carried out in the region of the maximum cross-sectional surface of the cup-shaped end in this manner. In order to facilitate the improved stability resulting from the shape of the worm the invention provides to also make the material selection such that according to the invention the worm is produced from alloy case-hardened steel 18 Cr Ni Mo 7-6.

It is further favorable if the connection means is a steep-angle taper or a hollow shaft taper seat, or a VDi seat having a chuck-body seat, and if slide disks for axially supporting the chuck body are provided in the chuck-body seat. It is known from the prior art to utilize ball bearings for support, usually ball bearings without cages, where, however, ball bearing seats are formed in the sliding surfaces at enormous loads due to the small bearing diameter, which have an adverse effect on the height of the achievable tension force. These disadvantages are avoided by the above mentioned characteristics.

In order to be able to supply coolants and lubricants to the tool gripped by the jaws, the chuck body is sealed opposite the connection means via seals, and that the means, the chuck body, and the pusher each comprise a throughgoing hole.

In order to prevent a tool having a smaller shaft diameter penetrating into the throughgoing hole the pusher is made such that the throughgoing hole of the pusher terminates offset from the central axis on the end facing the tool, it being preferred for simple production that the throughgoing hole of the pusher extends offset from the central axis axially all the way through it.

In order to prevent a tool having a larger shaft diameter from plugging up the throughgoing hole according to the invention a recess is formed at the end of the throughgoing hole of the pusher.

It is further within the scope of the invention that the worm is mounted in the connection means in a seat that extends tangentially of the chuck-body seat, and that the steep-angle taper forward of the rim has a frustoconical section on the end facing the chuck body and into which the worm seat opens. In this manner the chuck length remains as short as possible and the diameter of the drill chuck remains as small as possible. Furthermore, drilling chips flow off in an improved manner. The mass of the drill chuck is low, thus also reducing top-heaviness.

A short design is also facilitated in that the worm seat projects at least partially into a recess of the rim that is circumferentially discontinuous for seating a drive claw. For simplified balancing the invention provides at least one balancing cutout formed in at least one of the faces of the rim.

In order to reduce the risk of breakage of the worm the invention further provides that the inside diameter of the worm is enlarged toward the free end thereof in the region of the Torx socket, as the wall thickness especially in the region of the terminal of the Torx socket is increased in this manner. To this end the enlargement of the core diameter follows the chamfer diameter for a simplified production.

The invention is explained in further detail below with reference to the illustrated embodiments shown in the drawings. Therein:

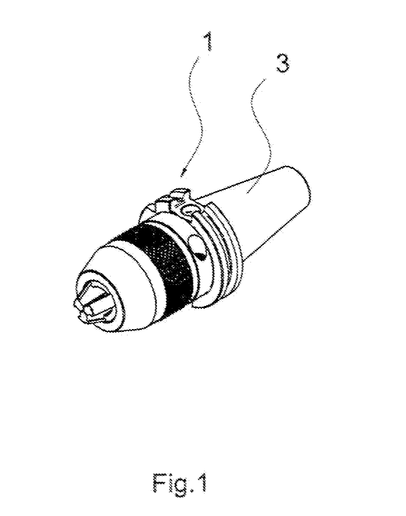

FIG. 1 is a perspective view of a drill chuck according to the invention,

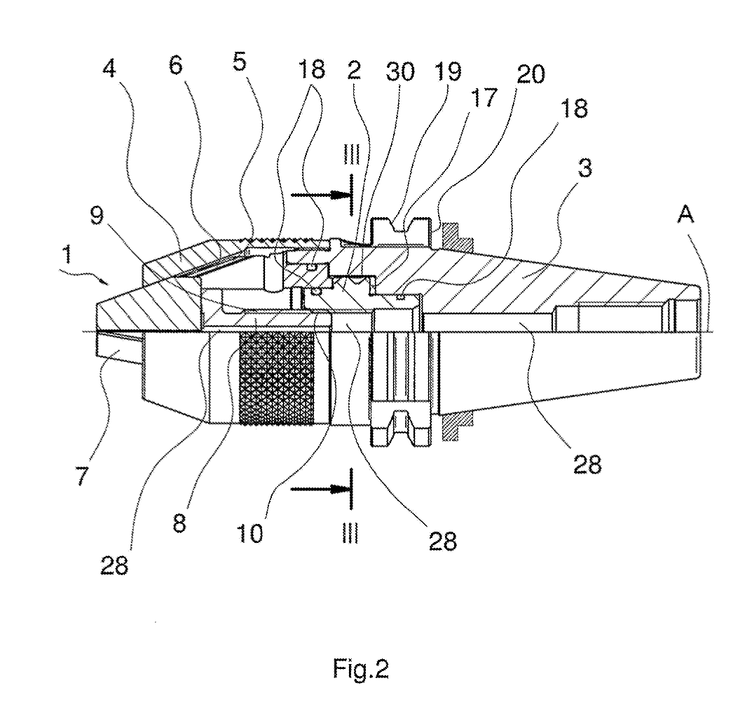

FIG. 2 is a partly sectioned side view of the drill chuck of FIG. 1,

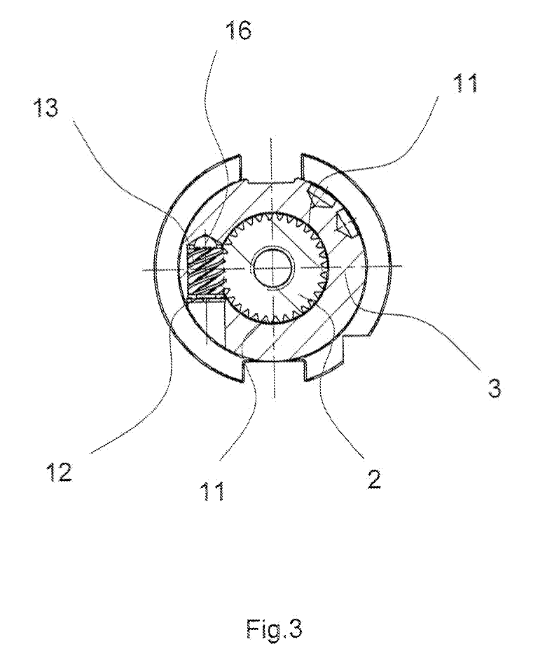

FIG. 3 is a section taken along line III-III of FIG. 2,

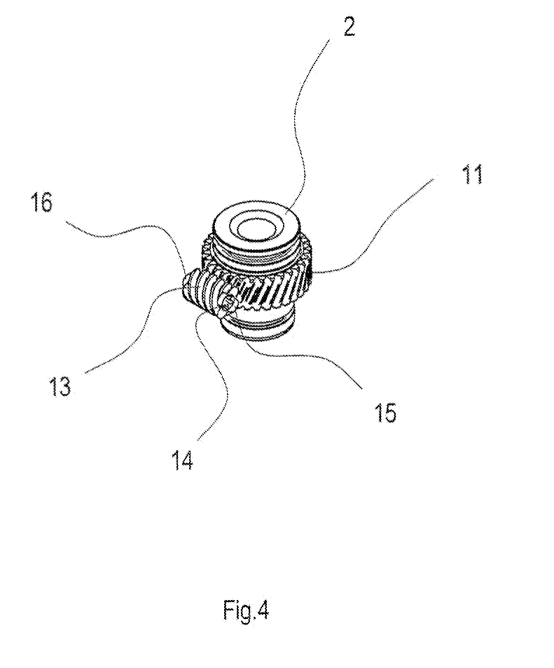

FIG. 4 is a perspective detail view of the worm and chuck body,

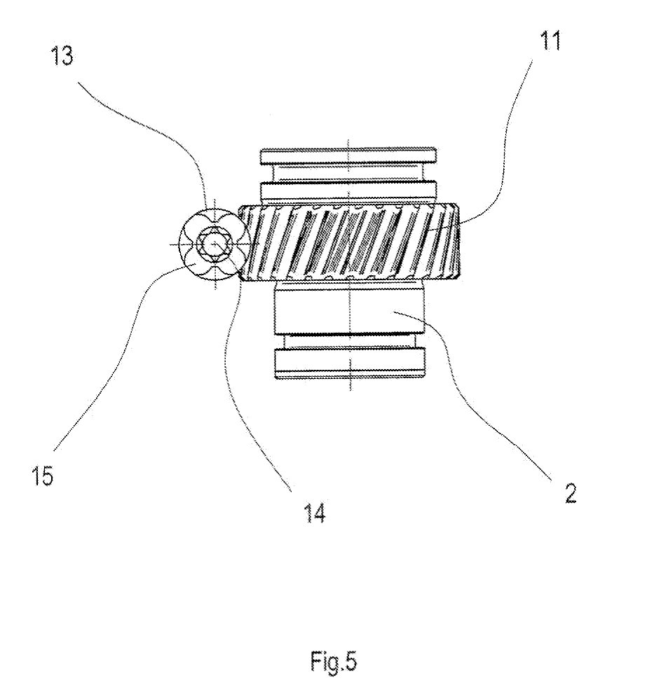

FIG. 5 is a side view of the chuck body and the worm,

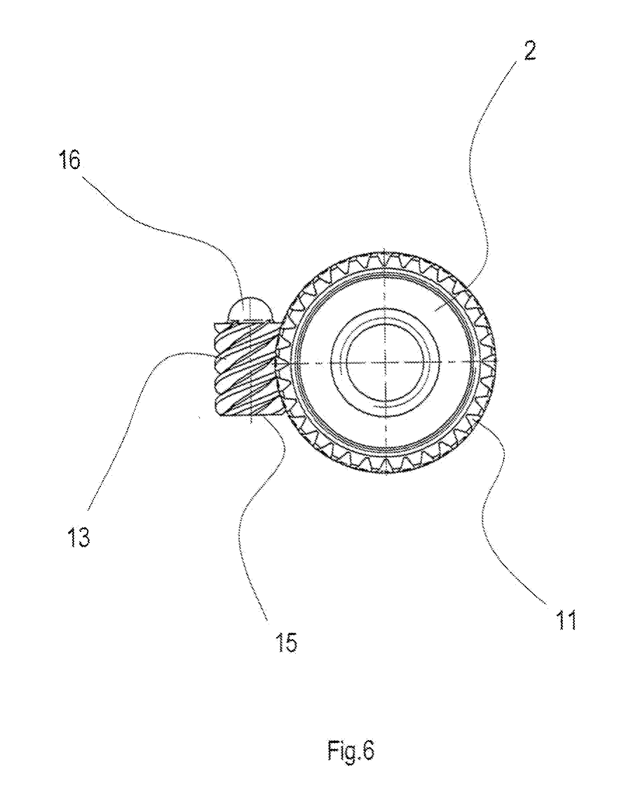

FIG. 6 is a top view of the structure of FIG. 5,

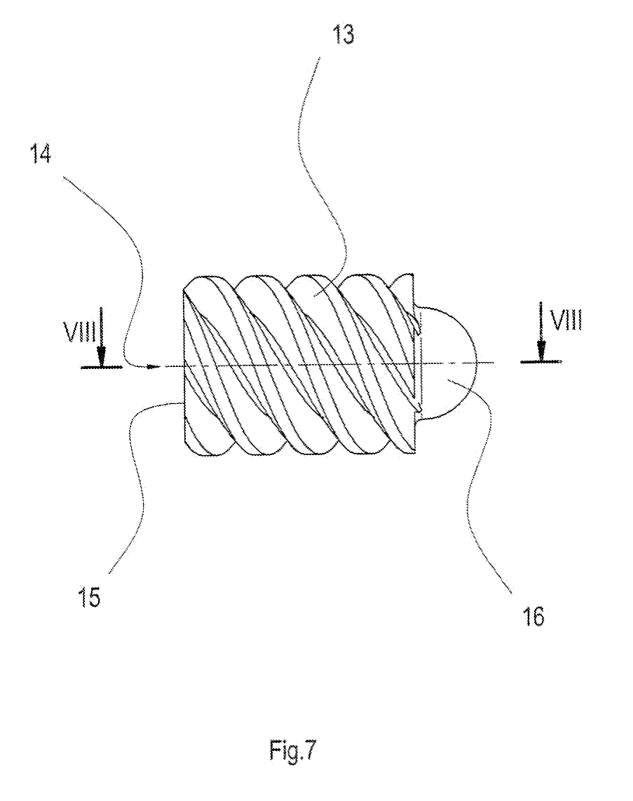

FIG. 7 is a side view of the worm,

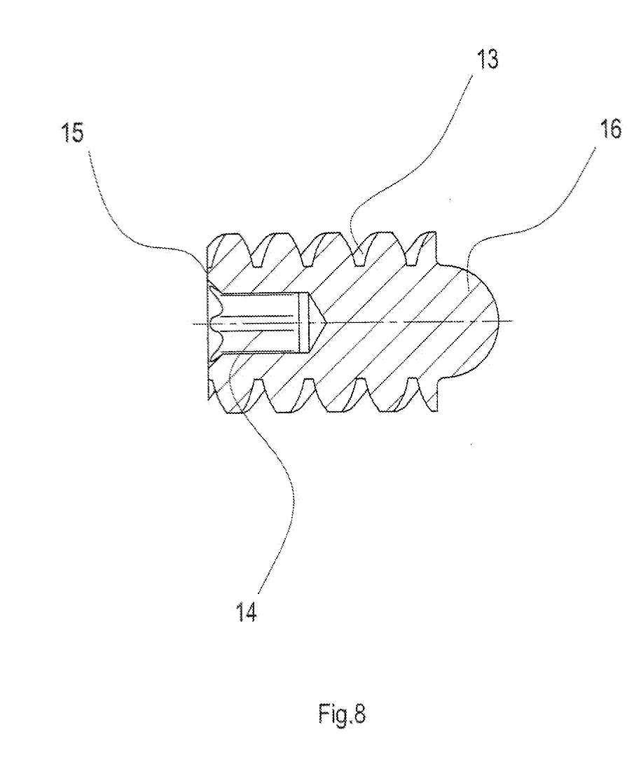

FIG. 8 is a section taken along line VIII-VIII of FIG.

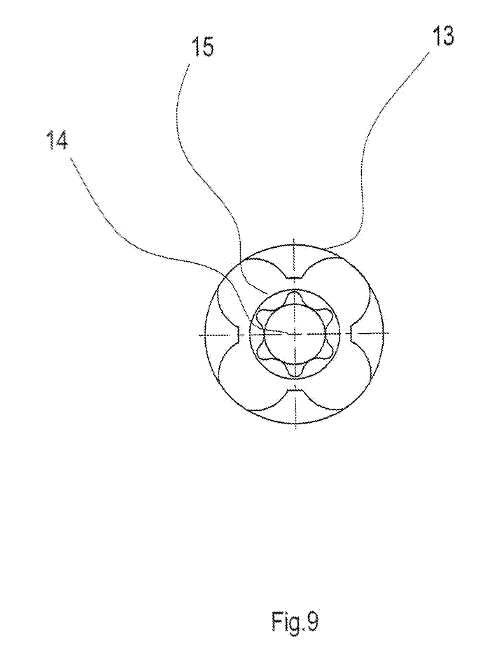

FIG. 9 is an end view of the worm,

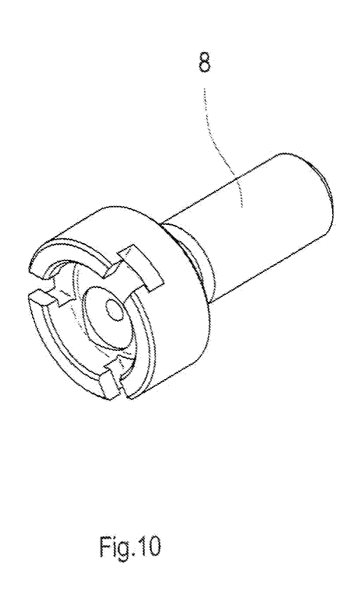

FIG. 10 is a perspective view of only the isolated pusher,

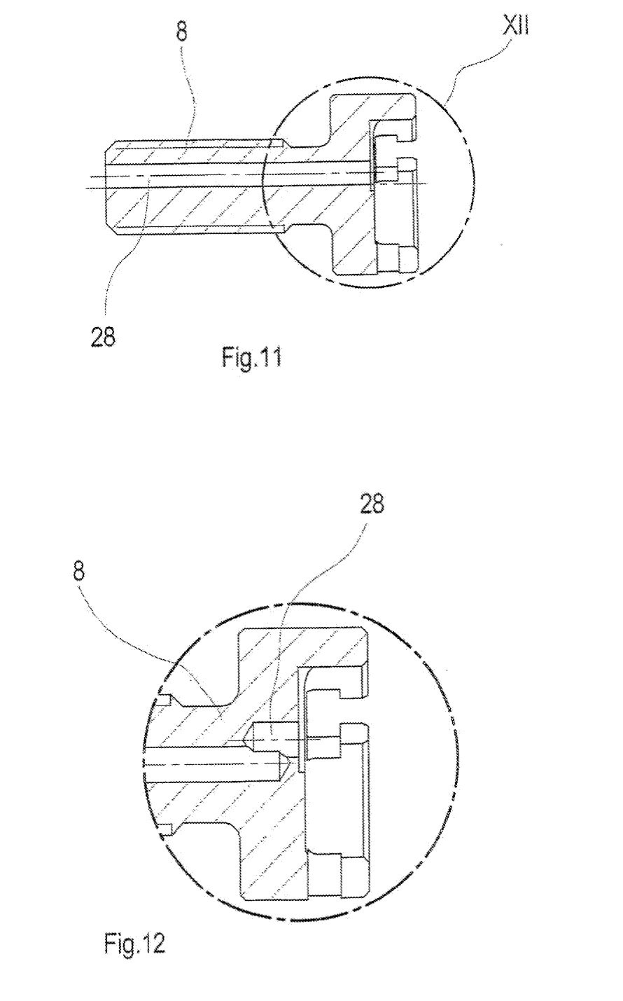

FIG. 11 is a longitudinal section through the pusher showing a cooling passage offset from the central axis,

FIG. 12 shows detail indicated at XII of FIG. 11, however with a bore offset from a tool contact point,

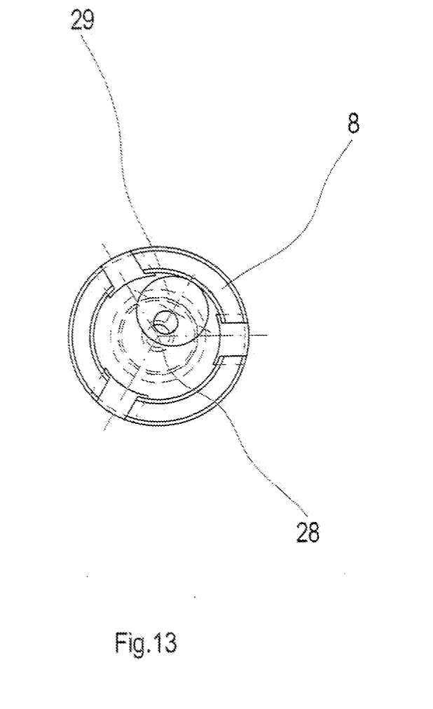

FIG. 13 is an end view of a face of the pusher,

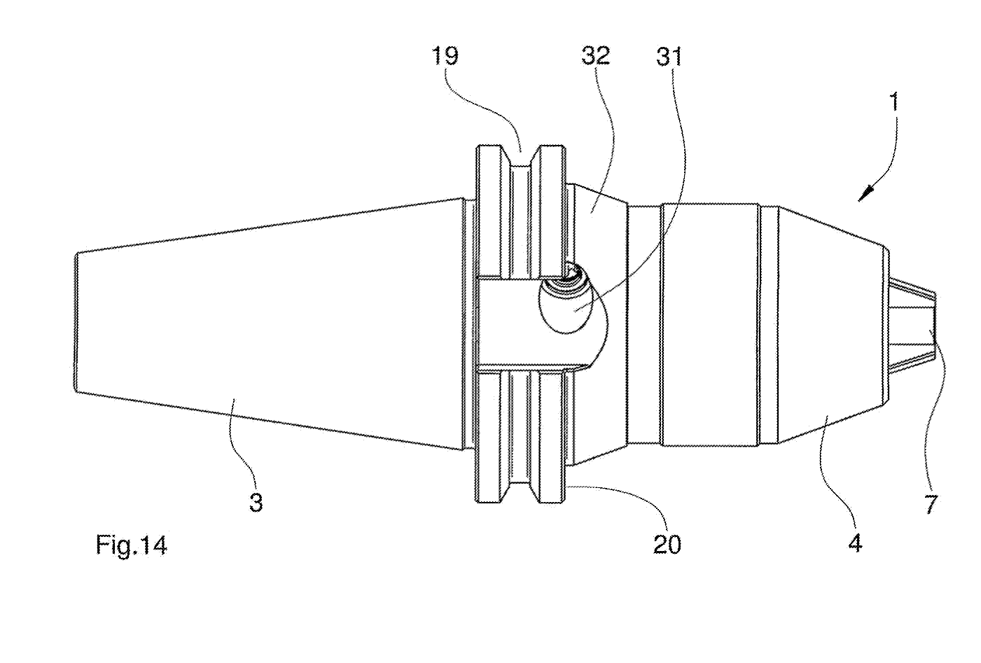

FIG. 14 is a side view of a further embodiment,

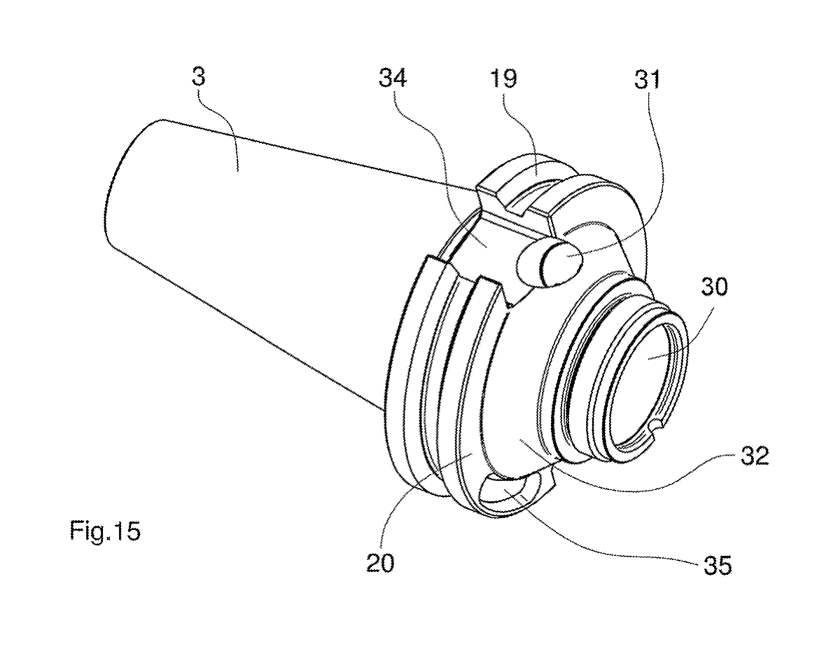

FIG. 15 is a perspective view of a steep-angle taper,

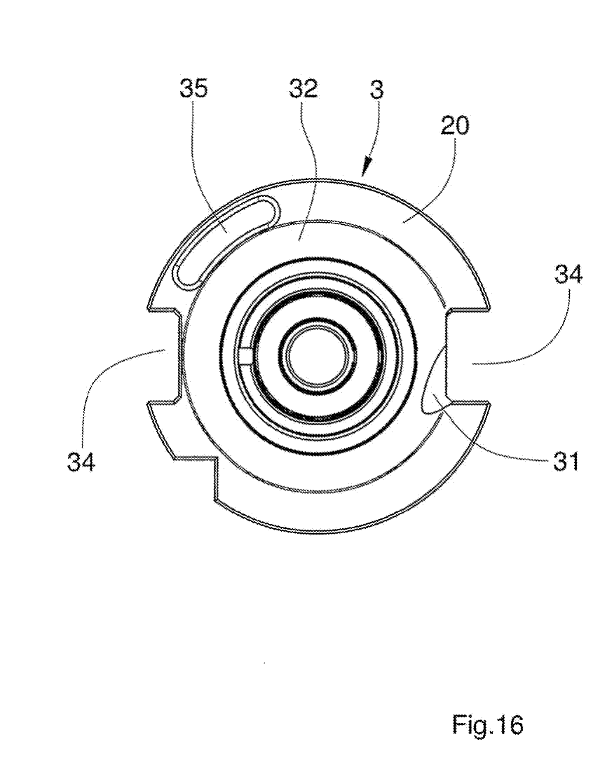

FIG. 16 is an end view of the steep-angle taper,

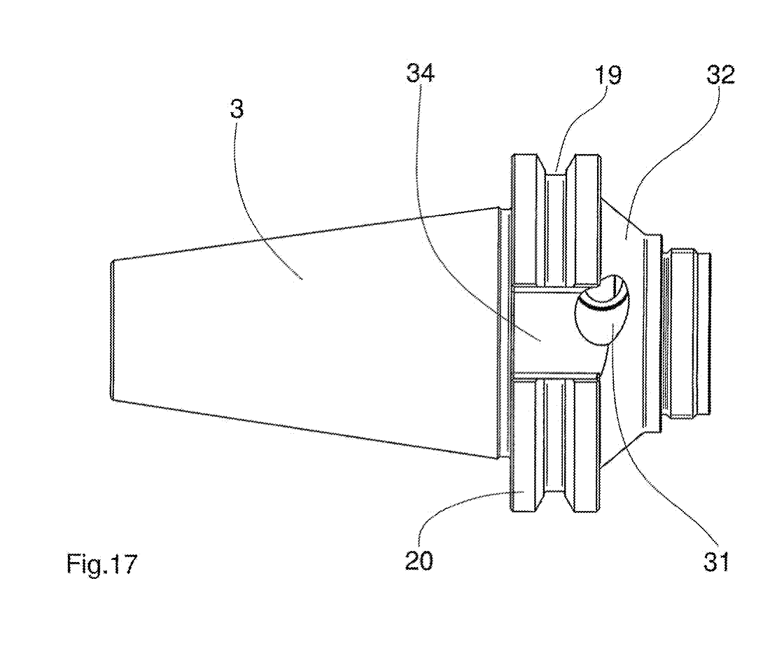

FIG. 17 is a side view of the steep-angle taper,

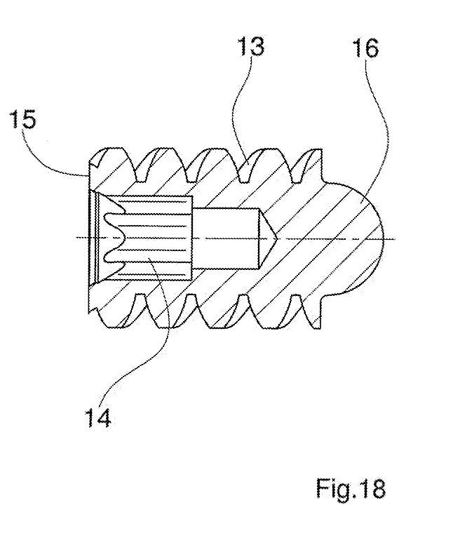

FIG. 18 is a view like FIG. 8 but showing the seat diameter flared toward the rim of the Torx socket, and

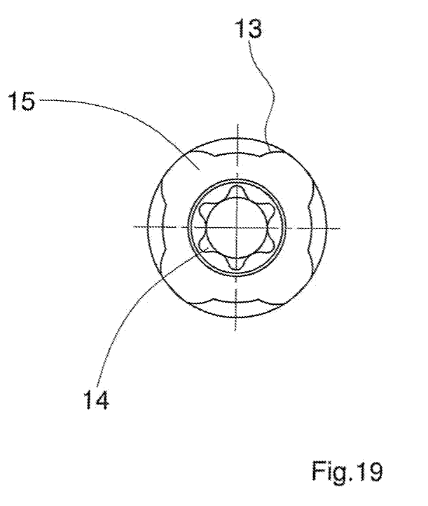

FIG. 19 is an view like FIG. 9 of the worm of FIG. 18.

The drawing shows a drill chuck 1 of small size, configured as a stud chuck, and comprising a chuck body 2 that in this embodiment can rotate in a steep-angle taper 3 so that it can be coupled to the work spindle of a work machine. The drill chuck 1 further comprises a tightening sleeve 4 rotatable coaxially relative to the chuck body 2, and a jaw guide 5 in which jaws 7 can slide in slots 6, moved radially by a pusher 8 for clamping and releasing by rotation of the chuck body 2 relative to the tightening sleeve 4, to which end the pusher 8 engages with a screwthread 9 in a screwthread 10 of the chuck body 2 that is coaxial to the chuck axis, an array of helical teeth 11 being formed on the chuck body 2 that is coaxial to the chuck axis and in which engages an externally accessible worm 13 mounted in the steep-angle taper 3 and having a coupling formation 12 and a worm axis that is usually perpendicular to the chuck axis and offset by a spacing equal to the sum of the radii of the chuck body 2 and of the worm 13.

The coupling formation 12 is a Torx socket 14 in an externally accessible end face 15 of the worm 13. To this end the end of the worm 13 opposite the end face 15 is formed with a semispherical seat 16. The worm 13, and optionally also the chuck body 2, are made of alloy case-hardened 18 Cr Ni Mo 7-6 steel.

Slide washers 17 in the chuck-body seat of the steep-angle taper 3 axial support the chuck body 2 that is sealed by seals 18 opposite to the steep-angle taper 3. The steep-angle taper 3, the chuck body 2, and the pusher 8 have respective throughgoing holes 28 through which coolants and/or lubricants may be fed from the work spindle to the tool.

With regard to the throughgoing hole 28 of the pusher 8 it should be noted that according to FIGS. 10 to 13 it is offset from the central axis, and opens into a recess 29 at the end thereof facing the tool.

FIGS. 14 to 17 show an embodiment where the worm 13 is mounted in the steep-angle taper 3 in a worm seat 31 that is tangential to the chuck-body seat 30, and the steep-angle taper has forward of its annular rim 20 on the end facing the chuck body 2 a frustoconical section 32 on which the worm seat 31 opens. More particularly, the worm seat 31 opens partially into or overlaps a cutout 34 of the rim 20 in the embodiment shown. Balancing cutouts 35 are formed in the front and rear faces of the rim 20.

FIGS. 18 and 19 show a modification of the worm 13, where the Torx socket 14 is flared outward toward its free end, this the enlargement of the core diameter being correlated with the bend of the curve of the tool that serving to make the worm thread.

The following is a brief description of how the drill chuck 1 according to the invention is used. To this end the rim 20 on the external circumference of the steep-angle taper 3 and equipped with a groove 19 is initially gripped by a manipulator such that the drill chuck 1 may be fitted to the seat of the work spindle automatically. For exchanging the workpiece or tool in the stud drill chuck a Torx tool is inserted into the Torx socket 14 of the worm 13 and it is initially rotated in the direction corresponding to the releasing action such that the jaws 7 open, because rotation of the worm 13 also rotates the chuck body 2 in the chuck-body seat of the steep-angle taper 3, and the pusher 8 therefore is screwed in the body thread 10 and is axially shifted rearward, thus guiding the jaws 7 radially outward in their slots 6. This enables removal of the shaft of the tool or workpiece from between the jaws 7 and insertion of a new shaft in its place, whereupon the rotation direction of the worm 13 is reversed to grip the new shaft. As soon as the jaws 7 contact the shaft the threaded engagement locks together the chuck body 2 and the worm 13 to prevent any further rotating of the chuck body 2 relative to the steep-angle taper 3 such that the drill chuck 1 may be safely operated both clockwise and counterclockwise rotation.

1. A drill chuck comprising:
a chuck body rotatable about a chuck axis,
means for connecting the chuck body to a drive spindle,
a tapered tightening sleeve rotatable coaxially relative to the chuck body,
a jaw guide having angled slots,
respective jaws slidable in the slots,
a pusher engageable with the jaws for clamping and releasing a tool on relative rotation of the chuck body and the tightening sleeve, the pusher having a screwthread engaged in a screwthread of the chuck body that is coaxial to the chuck axis,
an array of helical teeth being formed on the chuck body and coaxial to the chuck axis, and
an externally accessible worm mounted in the connecting means, engaging the teeth of the chuck body, and having a worm axis perpendicular to the chuck axis and offset therefrom by a distance equal to the sum of the radii of the chuck body and of the worm, and
a Torx socket formed in an externally accessible end face of the worm.

2. The drill chuck according to claim 1, wherein the worm has opposite the end face a cup-shaped end.

3. The drill chuck according to claim 2, wherein the cup-shaped end is of semispherical shape.

4. The drill chuck according to claim 1, wherein the worm is made from alloy case-hardened 18 Cr Ni Mo 7-6 steel.

5. The drill chuck according to claim 1, wherein the connection means is formed by a steep-angle taper or a hollow shaft taper seat, or a VDi seat having a chuck-body seat, and that slide disks are provided in the chuck-body seat for axially bracing the chuck body.

6. The drill chuck according to claim 5, wherein the chuck body is sealed by seals opposite the connection means, and the connection means, the chuck body, and the pusher are each formed with throughgoing hole.

7. The drill chuck according to claim 6, wherein the throughgoing hole of the pusher terminates at an end facing the tool offset from the central axis.

8. The drill chuck according to claim 7, wherein the throughgoing hole of the pusher extends axially completely therethrough offset from the central axis.

9. The drill chuck according to claim 6, wherein a recess is provided at an end of the throughgoing hole of the pusher.

10. The drill chuck according to claim 5 wherein the worm is held in the connection means in a worm seat that extends tangentially of the chuck-body seat.

11. The drill chuck according to claim 10 wherein the steep-angle taper has forward of a rim on the end facing the chuck body a frustoconical section into which the worm seat opens.

12. The drill chuck according to claim 10 wherein the worm seat at least partially projects into a cutout in a rim circumferentially interrupted for receiving a drive claw.

13. The drill chuck according to claim 5 wherein at least one balancing cutout is formed in at least one of the faces of the rim.

14. The drill chuck according to claim 1 wherein the inner diameter of the worm flares in the Torx socket toward the free end thereof.

15. The drill chuck according to claim 14 wherein the enlargement of the core diameter is correlated with the curvature of the diameter of the tool serving for making the worm thread.
